(19) United States
(12) Patent Application Publication
(10) Pub. No.: US 2005/0022612 A1
(43) Pub. Date: Feb. 3, 2005

(54) TORSION SENSOR

(76) Inventor: Heerke Hoogenberg, Rojssen (NL)

Correspondence Address: Richard L Byrne, 700 Koopers Building, 436 Seventh Avenue, Pittsburgh, PA, 15219-1818, US

(21) Appl. No.: 10/181,796

(22) PCT Filed: Jan. 9, 2001
(86) PCT No.: PCT/NL01/00009

(30) Foreign Application Priority Data
Jan. 24, 2000 (NL) 1014153

(51) Int. Cl. G01L 3/00

(52) U.S. Cl. 73/862.08

(57) ABSTRACT

The invention relates to a device for providing an axial force subject to a torque, which device has a first shaft with a friction surface comprising at least a radial directional component; a second shaft which is placed parallel with at least an axial directional component to the first shaft; a friction member arranged with an axial screw thread on the second shaft for friction contact with the friction surface, which friction member displaces axially in the case of rotation relative to the second shaft; and pressing means for urging the friction member in an axial direction.

The invention relates to a device for providing an axial force subject to a torque.

In transmissions wherein a torque is transmitted via a friction surface, it is required that sufficient pressing force be applied to the friction surface, since otherwise slippage will occur, thereby limiting the torque to be transmitted. If the torque varies, the same pressing force is then not constantly necessary. If a fixed pressing force is chosen, it must always be so great that the maximum torque can be transmitted. Due to this great pressing force the bearings of the transmission will be unnecessarily loaded in the case of partial load.

This problem occurs particularly in continuously variable transmissions. In such transmissions a driving torque is transmitted by friction to an opposite surface serving as friction surface. Depending on the demanded torque, a determined pressing force must be realized between the friction surfaces.

Devices are known for adjusting a certain pressing force which is subject to the torque, wherein the torque is measured and on the basis hereof a certain pressing force is then adjusted, for instance by means of hydraulics. These devices consume energy and are complicated and therefore expensive to manufacture and maintain.

It is an object of the invention to provide a simple device according to the preamble which obviates the drawbacks of known devices. This object is achieved according to the invention by a device according to the invention, comprising:
a first shaft with a friction surface comprising at least a radial directional component;
a first and second friction device, which device comprises:
a first shaft with a friction surface comprising at least a radial directional component;
a second shaft which is placed parallel with at least an axial directional component to the first shaft;
a friction member arranged with an axial screw thread on the second shaft for friction contact with the friction surface, which friction member is displaced axially in the case of rotation relative to the second shaft; and
pressing means for urging the friction member in an axial direction, wherein the first shaft of the first friction device forms an input shaft, which input shaft is arranged rotatably on the frame; wherein the second shaft of the second friction device forms an output shaft, which output shaft is arranged rotatably on the frame parallel to the input shaft and wherein the second shaft of the first friction device and the first shaft of the second friction device are mutually coupled to form a rotatable body, which rotatable body is arranged for at least radial displacement on the frame;
a first push belt arranged between the friction surface and the friction member of the first friction device;
a second push belt arranged between the friction surface and the friction member of the second friction device;
wherein the friction surfaces are rotation-symmetrical, the friction surfaces comprise at least an axial component and comprise at least a radial directional component.

When the first shaft is rotated with a certain torque, the first shaft will rotate relative to the friction member due to the screw thread. The friction member will hereby displace axially and press against the friction surface. When the pressing force is large enough to transmit the torque onto the second shaft, the rotation of the first shaft relative to the friction member will stop and the torque is transmitted from the first shaft onto the second shaft. The pressing means are arranged to ensure the first contact between the friction member and the friction surface.

The screw thread also provides a good radial centering of both shafts, whereby the bearing can remain relatively simple.

In a preferred embodiment roller bodies are arranged in the screw thread. These roller bodies considerably reduce the friction in the screw thread, whereby the pressing force is adjusted more precisely.

In another embodiment according to the invention the pressing means comprise a cup spring.

In a preferred embodiment according to the invention, one of the two shafts is axially displaceable and bounding means are arranged which engage on the friction member in order to limit the axial displacement of the friction member.

The ability to displace one of the two shafts makes it possible to also provide a clutch function in the transmission.

It is particularly desirable in the case of such a mechanical transmission to have a sufficiently great pressing force. On the other hand, this pressing force must not be too great, whereby unnecessary wear could occur.

In a preferred embodiment of the transmission according to the invention the pressing means of the first device and of the second device are shared.

In another embodiment of the transmission according to the invention at least one of the input shaft and the output shaft is axially displaceable and bounding means are arranged in order to bound the axial displacement of the friction member associated with the axially displaceable shaft.

A mechanical transmission with built-in clutch is formed using the above measures. Because the friction member is bounded in its axial displacement, a larger axial displacement of one of the shafts enables one of the two friction surfaces to be disengaged from the friction member. It is hereby possible to disengage the input shaft from the output shaft.

In a preferred embodiment according to the invention the friction surface arranged on the displaceable shaft comprises a first engaging surface.

When the mechanical transmission is also used as clutch, the friction surface arranged on the displaceable shaft will then wear excessively in that when the input shaft and the output shaft engage the push belt will slip over the friction surface. The operation of the mechanical transmission will be affected because the friction surface wears excessively. By now providing a special engaging surface only this surface will wear and the friction surface required for the mechanical transmission will remain intact.

In a further preferred embodiment according to the invention a second engaging surface is arranged on the push belt which engages on the friction surface associated with the displaceable shaft, wherein the first engaging surface lies outside the plane of the friction surface such that only the first engaging surface can co-act with the second engaging surface.

Owing to the slippage occurring between the push belt and the friction surface during engaging of the clutch, the push belt will also wear. By now providing on the push belt a special second engaging surface which can only co-act with a first engaging surface, wear to either the push belt or the friction surface will not affect the operation of the mechanical transmission.

These and other features of the invention will be further elucidated with reference to the annexed drawings:

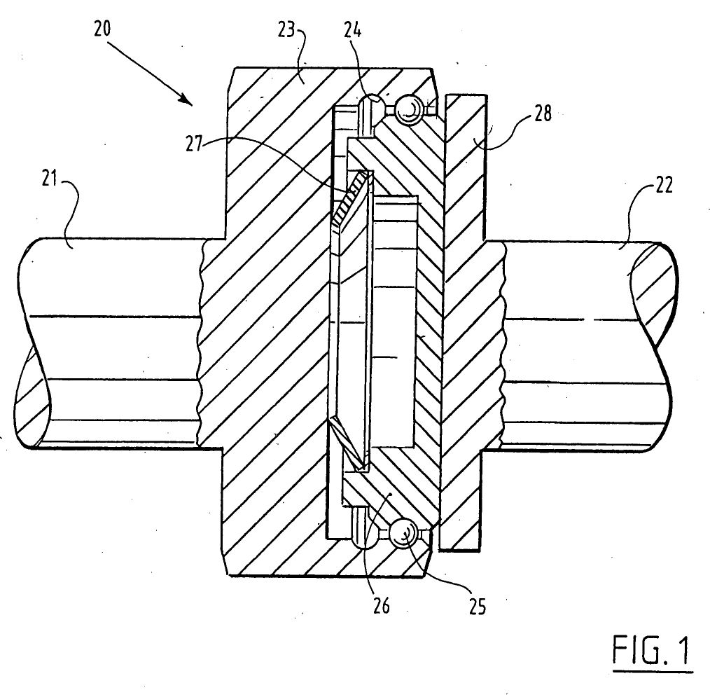

FIG. 1 shows a cross-section of a device according to the invention;

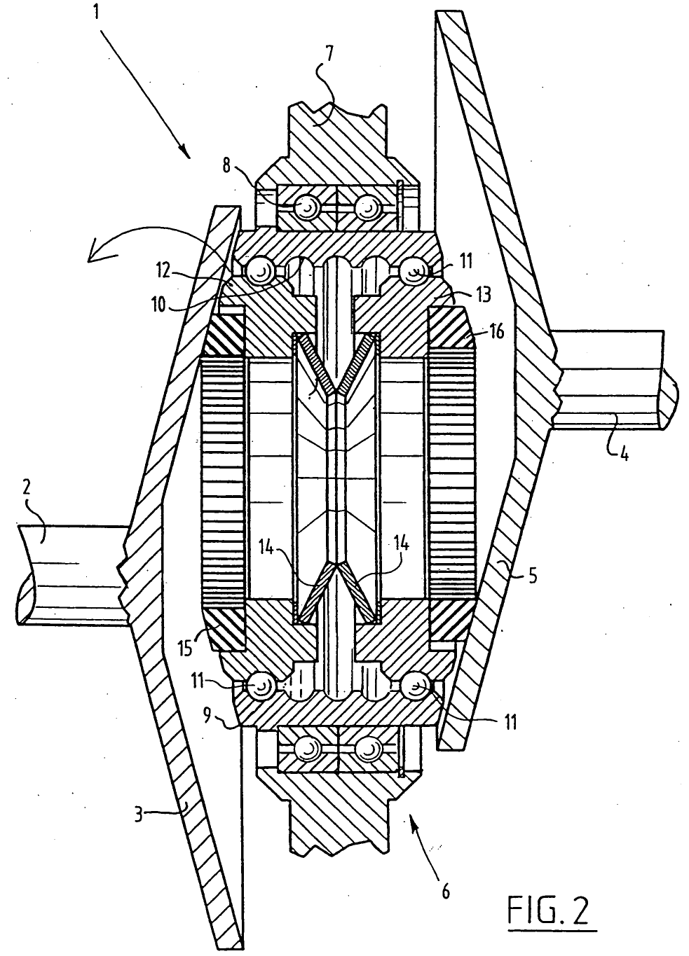

FIG. 2 shows a first embodiment of a mechanical transmission according to the invention;

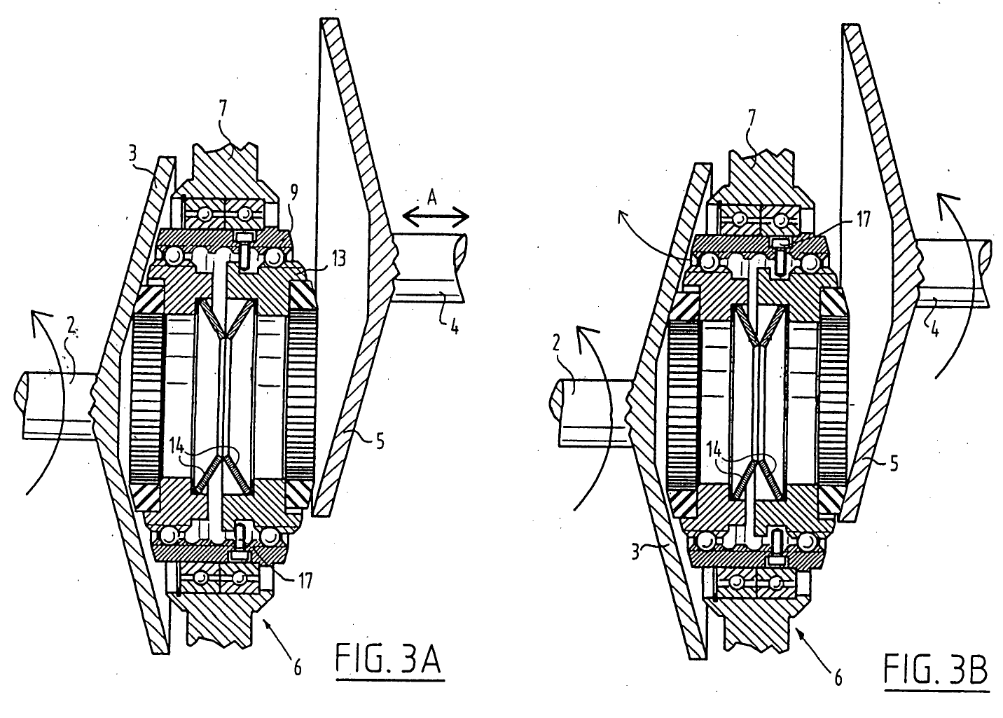

FIGS. 3a and 3b shows cross-sections of a second embodiment of a mechanical transmission according to the invention; and

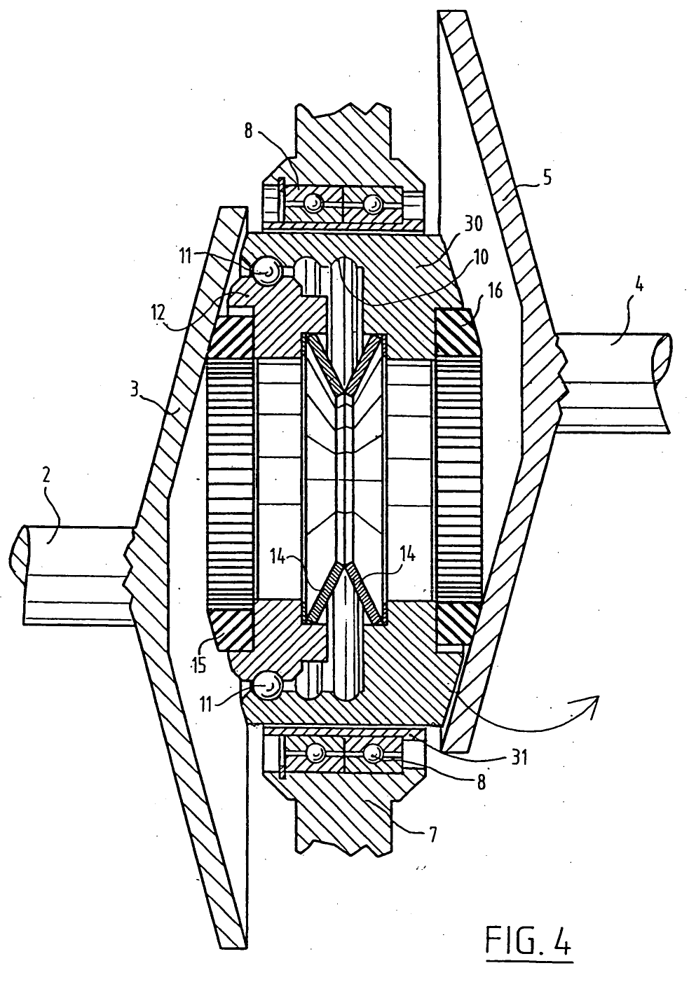

FIG. 4 shows a third embodiment of a mechanical transmission in which a device according to the invention is arranged.

FIG. 1 shows a device 20 according to the invention. Such devices 20 are usually designated as torque sensor. The device 20 has an input shaft 21 and an output shaft 22. Provided on input shaft 21 is a part 23 which has an internal screw thread 24. Arranged in this screw thread 24 are balls 25 which form a bearing for friction member 26. Friction member 26 is pressed against a friction surface 28 of output shaft 22 by means of cup springs 27.

When input shaft 21 is driven, it will carry along the friction member 26. Since friction member 26 is pressed against friction surface 28 of the stationary output shaft by cup springs 27, friction member 26 is held back in the first instance, whereby it will displace axially as a result of the screw thread. When the pressing force is sufficiently great, this axial displacement will stop and output shaft 22 will be carried along.

FIG. 2 shows a mechanical transmission 1 which comprises an input shaft 2 having thereon a friction surface 3, an output shaft 4 and a friction surface 5 arranged thereon. Between friction surfaces 3 and 5 is arranged a displaceable friction member 6 with which the transmission ratio between input shaft 2 and output shaft 4 can be adjusted.

Friction member 6 comprises a frame 7 which is displaceable. A bush 9 is mounted in this frame 7 via bearings 8. Bush 9 is provided on the inner side with a screw thread 10. Two bodies 12 and 13 are arranged in this screw thread by means of balls 11. Arranged between bodies 12 and 13 are cup springs 14 which urge the two bodies away from each other. Bodies 12 and 13 are provided on the sides directed toward the respective friction surfaces 3 and 5 with a push belt 15 respectively 16.

Cup springs 14 ensure that push belts 15, 16 are brought into contact with the respective friction surfaces 3 and 5. If a torque is now applied to shaft 2, the push belt 15, and therefore body 2, will be carried along by rotation of friction surface 3. Owing to the screw thread 10 the body 12 will now displace relative to bush 9 in the direction of friction surface 3. This will result in a certain pressing force of push belt 15 on friction surface 3. When the pressing force is sufficiently great, the bush 9 will be carried along by rotation of shaft 2.

In this mechanical transmission two pressing devices according to FIG. 1 are in fact arranged, each ensuring the correct pressing force of one of the push belts.

Since in the first instance the output shaft 4 stands still, the body 13 will be held back due to friction between push belt 16 and friction surface 5. Because bush 9 rotates, the body 13 will now displace relative to this bush toward friction surface 5, so that the pressing force between push belt 16 and friction surface 5 increases. As soon as the pressing force is sufficiently great, output shaft 4 will begin to rotate and a torque of input shaft 2 can thus be transmitted onto output shaft 4.

FIGS. 3a and 3b show a variant of the device according to FIG. 2. Corresponding components are designated with the same reference numerals and for the sake of simplicity will not be further described here.

The difference from the embodiment of FIG. 2 is that output shaft 4 is displaceable in the axial direction A. In bush 9 is arranged a securing member 17 which prevents the body 13 running out of the screw thread as a consequence of the cup springs 14 when output shaft 4 is moved away from friction member 6. FIG. 3a shows the disengaged position.

In FIG. 3b the output shaft 4 is once again placed against friction member 6, whereby body 13 is released from the securing member 17 and the mechanical transmission operates as shown in FIG. 2.

FIG. 4 shows a mechanical transmission which in construction largely corresponds with the embodiment shown in FIG. 2. Corresponding components are therefore designated with the same reference numerals.

In this embodiment the push belt 15 is also arranged in a body 12. Push belt 16 is arranged in a body 30. Body 12 is mounted in body 30 via roller bodies 11 and screw thread 10.

Placed coaxially on body 30 is a bush 31 which is axially displaceable relative to this body 30. This bush is mounted in frame 7 by means of bearings 8.

The operation corresponds for the most part with the operation of the embodiment of FIG. 2. The rotation of body 12 relative to body 30 ensures that the distance between the two push belts 15, 16 changes. In order to distribute the axial pressing force evenly over the two friction surfaces 3, 5, the body 30 will displace axially in bush 31.

The advantage of this construction is that the bearings 8 are not axially loaded and the frame therefore also remains unloaded in axial direction.

1. Mechanical transmission, comprising:
a frame;
a first and second friction device, which device comprises:
a first shaft with a friction surface comprising at least a radial directional component;
a second shaft which is placed parallel with at least an axial directional component to the first shaft;
a friction member arranged with an axial screw thread on the second shaft for friction contact with the friction surface, which friction member is displaced axially in the case of rotation relative to the second shaft; and
pressing means for urging the friction member in an axial direction, wherein the first shaft of the first friction device forms an input shaft, which input shaft is arranged rotatably on the frame; wherein the second shaft of the second friction device forms an output shaft, which output shaft is arranged rotatably on the frame parallel to the input shaft and wherein the second shaft of the first friction device and the first shaft of the second friction device are mutually coupled to form a rotatable body, which rotatable body is arranged for at least radial displacement on the frame;
a first push belt arranged between the friction surface and the friction member of the first friction device;
a second push belt arranged between the friction surface and the friction member of the second friction device;
wherein the friction surfaces are rotation-symmetrical, the friction surfaces comprise at least an axial component and comprise at least a radial directional component.

2. Transmission as claimed in claim 1, wherein the pressing means of the first device and of the second device are shared.

3. Transmission as claimed in claim 1, wherein at least one of the input shaft and the output shaft is axially displaceable and wherein bounding means are arranged in order to bound the axial displacement of the friction member associated with the axially displaceable shaft.

4. Transmission as claimed in claim 3, wherein the friction surface arranged on the displaceable shaft comprises a first engaging surface.

5. Transmission as claimed in claim 4, wherein a second engaging surface is arranged on the push belt which engages on the friction surface associated with the displaceable shaft, wherein the first engaging surface lies outside the plane of the friction surface such that only the first engaging surface can co-act with the second engaging surface.
